(19) United States
(12) Patent Application Publication
(10) Pub. No.: US 2019/0377489 A1
(43) Pub. Date: Dec. 12, 2019

(54) ARTIFICIAL INTELLIGENCE DEVICE FOR PROVIDING VOICE RECOGNITION SERVICE AND METHOD OF OPERATING THE SAME

(71) Applicant: LG ELECTRONICS INC., Seoul (KR)

(72) Inventors: Jongwoo HAN, Seoul (KR); Kevin Kyoungup PARK, Seoul (KR)

(73) Assignee: LG ELECTRONICS INC., Seoul (KR)

(21) Appl. No.: 16/551,631

(22) Filed: Aug. 26, 2019

(30) Foreign Application Priority Data
Jul. 25, 2019 (KR) 10-2019-0090403

(51) Int. Cl. G06F 3/0488; G06F 3/16; G10L 15/22; G10L 17/18; G10L 25/30

(52) U.S. Cl. CPC G06F 3/04886; G06F 3/167; G10L 2015/223; G10L 17/18; G10L 25/30; G10L 15/22

(57) ABSTRACT

An artificial intelligence (AI) device for providing a voice recognition function includes a microphone, a display unit, a memory configured to store a touch input pattern classification model, and a processor configured to detect a touch input pattern, acquire a touch input pattern group corresponding to the touch input pattern using the touch input pattern classification model, output a notification for registering a voice macro corresponding to the touch input pattern group, and generate the voice macro by matching a voice command to the touch input pattern group as the voice command is received through the microphone.

### CROSS-REFERENCE TO RELATED APPLICATION

Pursuant to 35 U.S.C. § 119(a), this application claims the benefit of earlier filing date and right of priority to Korean Patent Application No. 10-2019-0090403, filed on Jul. 25, 2019, the contents of which are hereby incorporated by reference herein in its entirety.

### BACKGROUND

The present invention relates to an artificial intelligence device for providing a voice recognition service.

Competition for voice recognition technology which has started in smartphones is expected to become fiercer in the home with diffusion of the Internet of things (IoT).

In particular, an artificial intelligence (AI) device capable of issuing a command using voice and having a talk is noteworthy.

A voice recognition service has a structure for selecting an optimal answer to a user's question using a vast amount of database.

A voice search function refers to a method of converting input voice data into text in a cloud server, analyzing the text and retransmitting a real-time search result to a device.

Users often use repetitive input when using artificial intelligence devices. For example, in the case of a smartphone, a repetitive touch input pattern is often used when a specific application is used. For example, a user repeatedly uses scroll input when viewing a web page.

Performing such a repetitive input pattern may cause inconvenience or troublesomeness to the user.

### SUMMARY

An object of the present invention is to provide an artificial intelligence device capable of performing a repetitive input pattern by only uttering voice without user input.

Another object of the present invention is to control an artificial intelligence device through utterance of voice even if it is difficult for a user to use touch input.

An artificial intelligence (AI) device for providing a voice recognition function according to an embodiment of the present invention includes a microphone, a display unit, a memory configured to store a touch input pattern classification model, and a processor configured to detect a touch input pattern, acquire a touch input pattern group corresponding to the touch input pattern using the touch input pattern classification model, output a notification for registering a voice macro corresponding to the touch input pattern group, and generate the voice macro by matching a voice command to the touch input pattern group as the voice command is received through the microphone.

A method of operating an artificial intelligence (AI) device for providing a voice recognition function according to another embodiment of the present invention includes detecting a touch input pattern, acquiring a touch input pattern group corresponding to the touch input pattern using a touch input pattern classification model, outputting a notification for registering a voice macro corresponding to the touch input pattern group, and generating the voice macro by matching a voice command to the touch input pattern group as the voice command is received through a microphone.

### BRIEF DESCRIPTION OF THE DRAWINGS

FIG. 1 is a view showing an artificial intelligence (AI) device according to an embodiment of the present invention.

FIG. 2 is a view showing an AI server according to an embodiment of the present invention.

FIG. 3 is a view showing an AI system according to an embodiment of the present invention.

FIG. 4 is a view showing an artificial intelligence (AI) device according to another embodiment of the present invention.

FIG. 5 is a flowchart illustrating a method of operating an AI device for providing a voice recognition service according to an embodiment of the present invention.

FIGS. 6 and 7 are views illustrating a process of classifying a touch input pattern into a specific touch input pattern group through a touch input pattern classification model according to an embodiment of the present invention.

FIGS. 8a to 8d are views illustrating a process of automatically registering a voice macro according to an embodiment of the present invention.

FIGS. 9a to 9d are views illustrating a process of manually registering a voice macro according to an embodiment of the present invention.

FIGS. 10 and 11 are views illustrating scenarios which may occur in a state in which operation of a voice macro cannot be performed.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

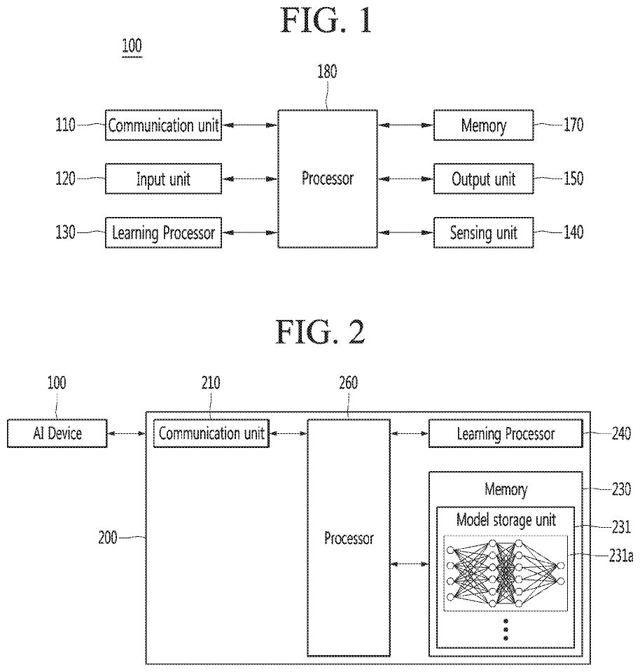

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

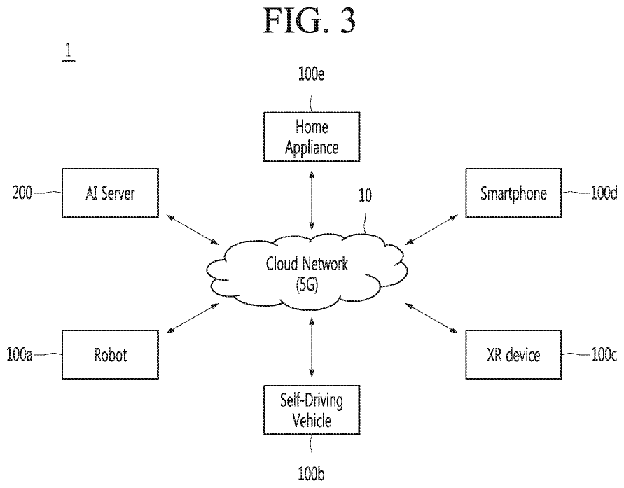

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

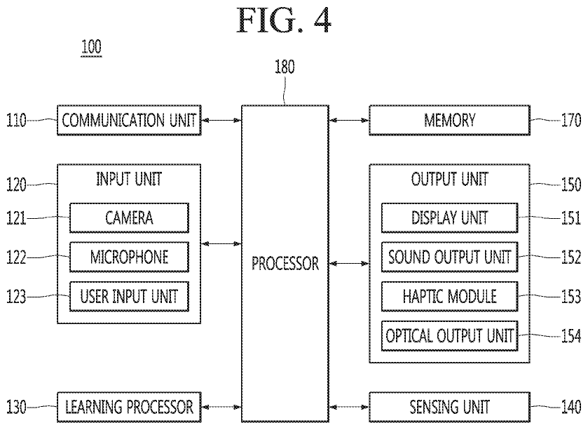

FIG. 4 shows an AI device 100 according to an embodiment of the present invention.

A repeated description of FIG. 1 will be omitted.

Referring to FIG. 4, an input unit 120 may include a camera 121 for receiving a video signal, a microphone 122 for receiving an audio signal and a user input unit 123 for receiving information from a user.

Audio data or image data collected by the input unit 120 may be analyzed and processed as a control command of the user.

The input unit 120 receives video information (or signal), audio information (or signal), data or information received from the user, and the AI device 100 may include one or a plurality of cameras 121 for input of the video information.

The camera 121 processes an image frame such as a still image or a moving image obtained by an image sensor in a video call mode or a shooting mode. The processed image frame may be displayed on a display unit 151 or stored in a memory 170.

The microphone 122 processes external acoustic signals into electrical sound data. The processed sound data may be variously utilized according to the function (or the application program) performed in the AI device 100. Meanwhile, various noise removal algorithms for removing noise generated in a process of receiving the external acoustic signal is applicable to the microphone 122.

The user input unit 123 receives information from the user. When information is received through the user input unit 123, a processor 180 may control operation of the AI device 100 in correspondence with the input information.

The user input unit 123 may include a mechanical input element (or a mechanical key, for example, a button located on a front/rear surface or a side surface of the terminal 100, a dome switch, a jog wheel, a jog switch, and the like) and a touch input element. As one example, the touch input element may be a virtual key, a soft key or a visual key, which is displayed on a touchscreen through software processing, or a touch key located at a portion other than the touchscreen.

An output unit 150 may include at least one of a display unit 151, a sound output unit 152, a haptic module 153, and an optical output unit 154.

The display unit 151 displays (outputs) information processed in the AI device 100. For example, the display unit 151 may display execution screen information of an application program executing at the AI device 100 or user interface (UI) and graphical user interface (GUI) information according to the execution screen information.

The display unit 151 may have an inter-layered structure or an integrated structure with a touch sensor so as to implement a touchscreen. The touchscreen may provide an output interface between the terminal 100 and a user, as well as functioning as the user input unit 123 which provides an input interface between the AI device 100 and the user.

The sound output unit 152 may output audio data received from a communication unit 110 or stored in the memory 170 in a call signal reception mode, a call mode, a record mode, a voice recognition mode, a broadcast reception mode, and the like.

The sound output unit 152 may include at least one of a receiver, a speaker, a buzzer or the like.

The haptic module 153 may generate various tactile effects that can be felt by a user. A representative example of tactile effect generated by the haptic module 153 may be vibration.

The optical output unit 154 may output a signal indicating event generation using light of a light source of the AI device 100. Examples of events generated in the AI device 100 may include a message reception, a call signal reception, a missed call, an alarm, a schedule notice, an email reception, an information reception through an application, and the like.

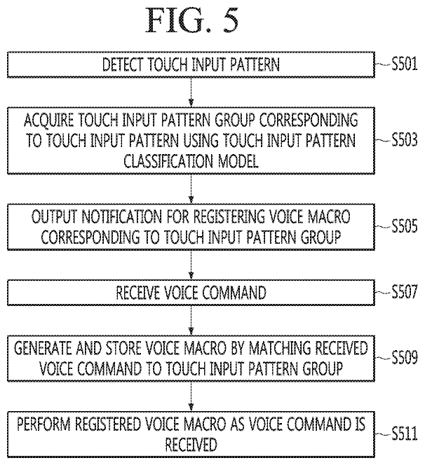

FIG. 5 is a flowchart illustrating a method of operating an AI device for providing a voice recognition service according to an embodiment of the present invention.

The processor 180 of the AI device 100 detects a touch input pattern through the display unit 151 (S501).

In one embodiment, the touch input pattern may include one or more of a direction of touch input, a movement distance of touch input, a position of touch input, the count of touch input or a type of an item selected through touch input.

The item selected through touch input may be a menu for operation control of the AI device 100 or an application installed in the AI device 100.

The processor 180 acquires a touch input pattern group corresponding to the detected touch input pattern using a touch input pattern classification model (S503).

The touch input pattern classification model may be an artificial neural network based model learned through a deep learning algorithm or a machine learning algorithm.

The touch input pattern classification model may be a model learned by the learning processor 130 of the AI device 100 and stored in the memory 170.

In another example, the touch input pattern classification model may be learned by the learning processor 240 of the AI server 200, received from the AI server 200 and stored in the memory 170.

The touch input pattern classification model may be a model learned through unsupervised learning.

Unsupervised learning is a learning method in which learning data is not labeled unlike supervised learning in which learning data is labeled.

Unsupervised learning may be a learning method of training an artificial neural network to find and classify a pattern in learning data.

Examples of unsupervised learning may include grouping or independent component analysis.

In this specification, the term “grouping” may be used interchangeably with “clustering”.

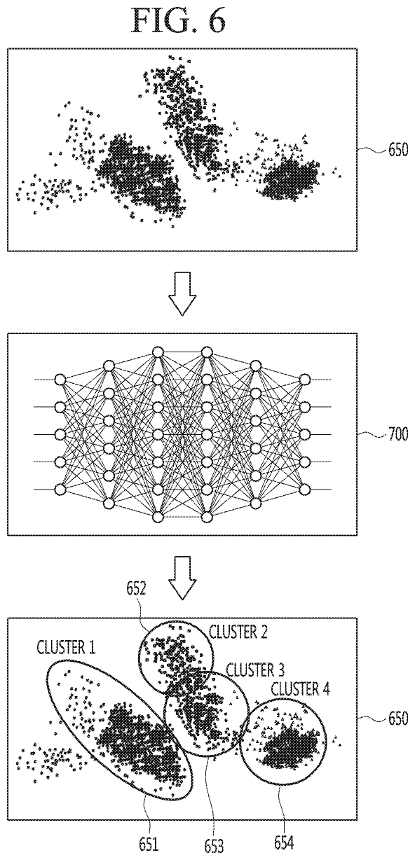

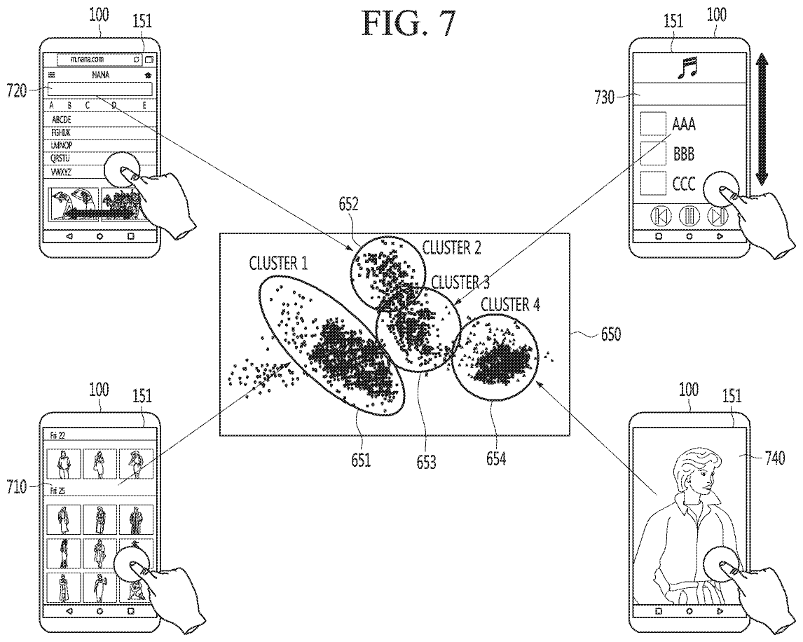

The touch input pattern classification model will be described with reference to FIGS. 6 and 7.

FIGS. 6 and 7 are views illustrating a process of classifying a touch input pattern into a specific touch input pattern group through a touch input pattern classification model according to an embodiment of the present invention.

Referring to FIG. 6, a touch input data set 650 including touch data for a plurality of touch input patterns may be collected.

The touch input data set 650 may include information on touch input patterns performed when a specific application is executed or when a function of the AI device 100 is operated.

The touch input data set 650 may be input to the touch input pattern classification model 700 as learning data.

The learning processor 130 of the AI device 100 or the processor 180 may train the touch input pattern classification model 700 to cluster the touch input data set 650 through unsupervised learning.

The touch input pattern classification model 700 may classify touch input data having similar patterns from the touch input data set 650 using the direction of touch input, the movement distance of touch input, a touch position, a touch count, etc.

The touch input pattern classification model 700 may classify the touch input data set 650 into a plurality of touch input pattern groups 651, 652, 653 and 654 according to the result of classification.

Next, FIG. 7 will be described.

Referring to FIG. 7, a first touch input pattern group 651 may include touch input patterns used when a user displays an execution screen 710 of a gallery application.

That is, the touch input patterns collected when the user executes the gallery application may be classified as the first touch input pattern group 651 having a first touch pattern.

The first touch pattern may have a pattern in which touch input is repeatedly detected at a plurality of positions on the display unit 151.

A second touch input pattern group 652 may include touch input patterns used when a user displays an execution screen 720 of an Internet application.

That is, the touch input patterns collected when the user executes the Internet application may be classified as the second touch input pattern group 652 having a second touch pattern.

The second touch pattern may be a pattern in which touch input is repeated in upward/downward/left/right directions.

A third touch input pattern group 653 may include touch input patterns used when a user displays an execution screen 730 of a music application.

That is, the touch input patterns collected when the user executes the music application may be classified as the third touch input pattern group 653 having a third touch pattern.

The third touch pattern may be a pattern in which up/down scroll and touch input at a specific position are repeated.

A fourth touch input pattern group 654 may include touch input patterns used when a user displays an execution screen 740 of a video playback application.

That is, the touch input patterns collected when the user executes the video playback application may be classified as the fourth touch input pattern group 654 having a fourth touch pattern.

The fourth touch pattern may be a pattern in which touch input is repeated only in a specific area of the display unit 151.

FIG. 5 will be described again.

The processor 180 outputs a notification for registering a voice macro corresponding to the touch input pattern group (S505).

In one embodiment, the voice macro may be a function for performing a predetermined touch input pattern in response to a voice command of a user.

The voice macro may be a function for executing a predetermined application and performing a predetermined touch input pattern on an execution screen of the executed application in response to the voice command of the user.

The voice macro may be a function for inputting a touch pattern corresponding to a touch input pattern group to the display unit 151.

The voice macro may be a function for inputting the touch pattern to the display unit 151 when a specific application is executed.

The processor 180 may output a notification for registering the voice macro when the detected touch input pattern belongs to any one of a plurality of pre-classified touch input pattern groups.

The processor 180 may display the notification through the display unit 151.

The processor 180 receives a voice command through the microphone 122 (S507), and generates and stores the voice macro in the memory 170, by matching the received voice command to the touch input pattern group (S509).

That is, the processor 180 may generate the voice macro, by matching the received voice command to the touch input pattern group, to which the detected touch input pattern belongs.

The voice macro may include a correspondence relation between the voice command and a touch pattern of a touch input pattern group matching the voice command.

The registered voice command may be a wake-up word for automatically executing the voice macro corresponding thereto.

The processor 180 performs the registered voice macro as the voice command is received (S511).

The processor 180 may extract the voice macro corresponding to the registered voice command from the memory 170, when the registered voice command is received.

The processor 180 may execute the extracted voice macro. That is, the processor 180 may input a specific touch input pattern matching the voice command to the display unit 151 as the voice command is received.

According to one embodiment of the present invention, the user can easily input a touch input pattern, which has been repeatedly input, by only voice.

In addition, input control can be conveniently performed even in a state in which it is difficult for the user to use touch input.

In addition, input and control of various applications are possible even if an application does not provide a voice recognition function.

Hereinafter, the embodiment of FIG. 5 will be described in greater detail.

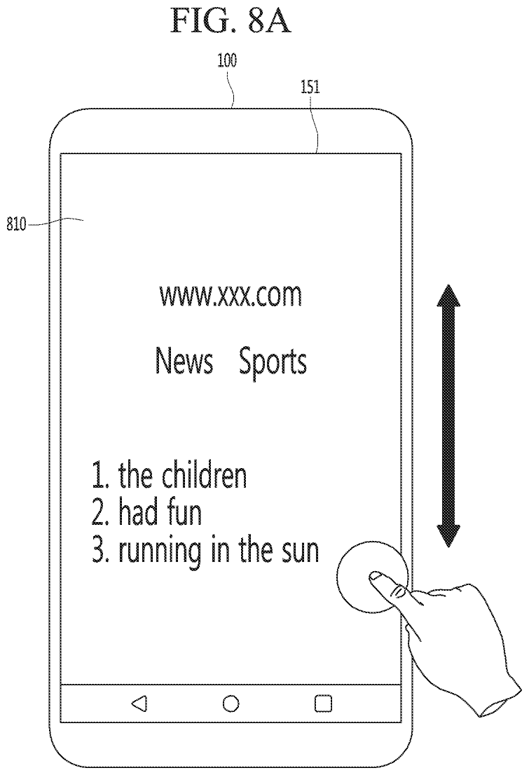

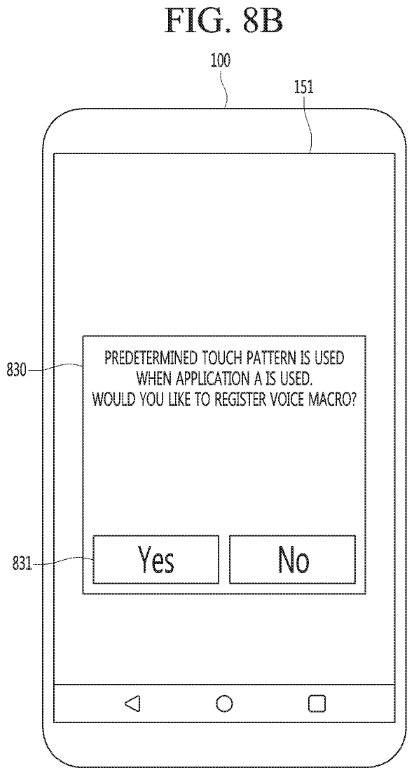

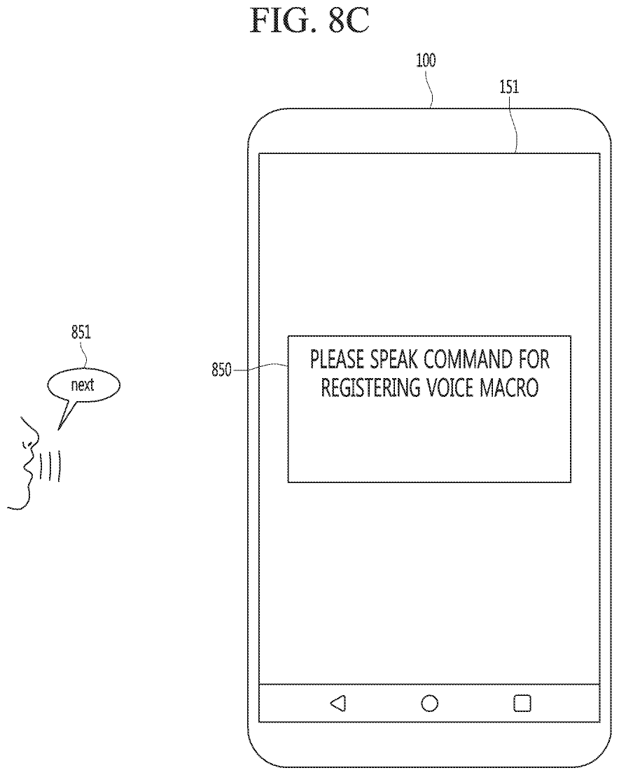

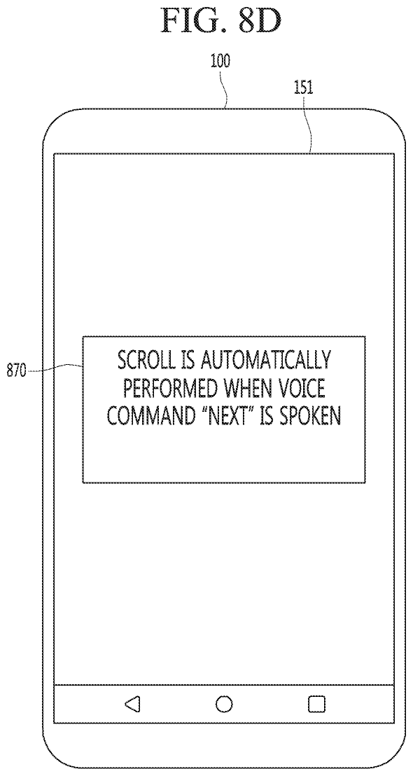

FIGS. 8a to 8d are views illustrating a process of automatically registering a voice macro according to an embodiment of the present invention.

Referring to FIG. 8a, the AI device 100 displays an execution screen 810 of an Internet application on the display unit 151 as the Internet application is executed.

The AI device 100 may detect a specific touch input pattern on the execution screen 810.

The AI device 100 may acquire a touch input pattern group, to which the touch input pattern belongs, using the touch input pattern classification model, when the specific touch input pattern is detected.

When the acquired touch input pattern belongs to any one of a plurality of touch input pattern groups, as shown in FIG. 8b, the AI device 100 may display a notification window 830 for inquiring about registration of the voice macro on the display unit 151.

When a Yes button 831 included in the notification window 830 is selected, as shown in FIG. 8c, the AI device 100 may display a notification window 850 for requesting utterance of a voice command on the display unit 151, in order to register the voice macro.

The AI device 100 may receive a voice command 851 <next> from the user through the microphone 122.

The AI device 100 may register the voice macro by matching the received voice command 851 to a predetermined touch pattern.

As shown in FIG. 8d, the AI device 100 may display a voice macro guide window 870 for guiding use of the voice macro according to registration of the voice macro on the display unit 151.

According to registration of the voice macro, the touch input pattern repeated by the user is automatically performed by only voice, thereby greatly improving user convenience.

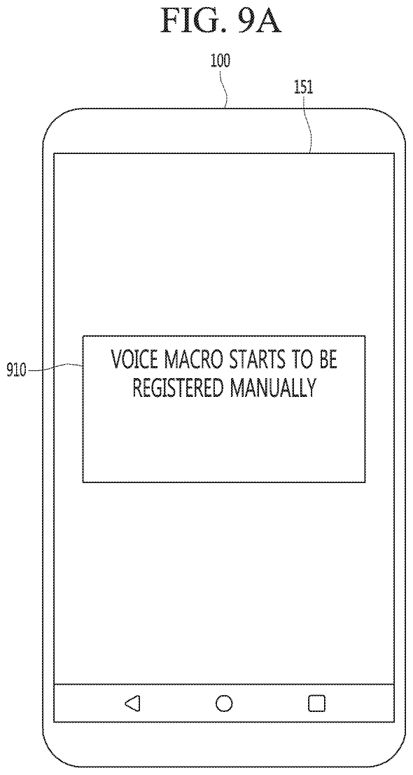

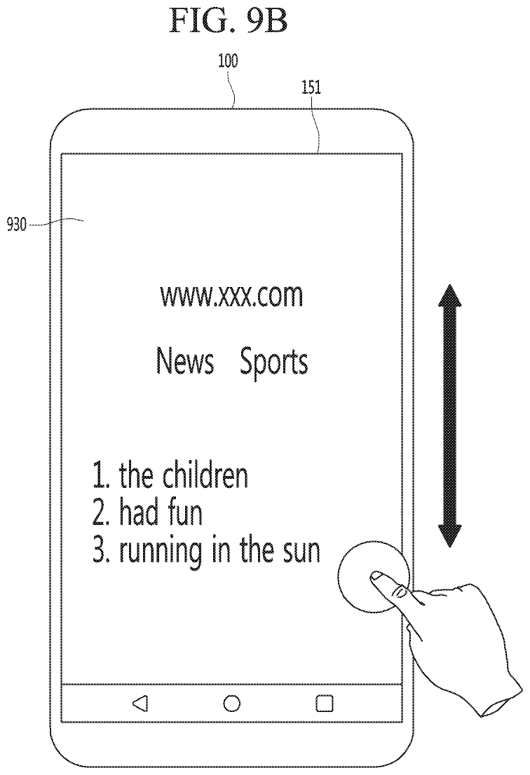

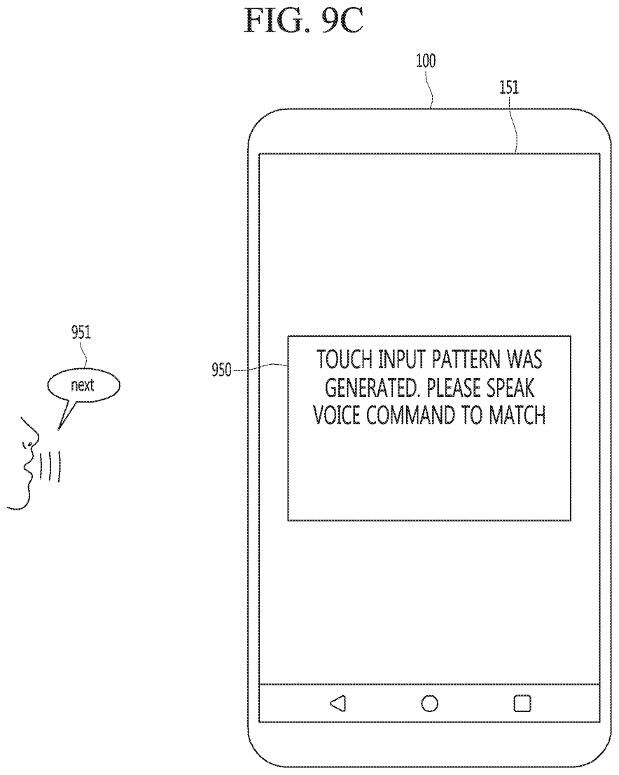

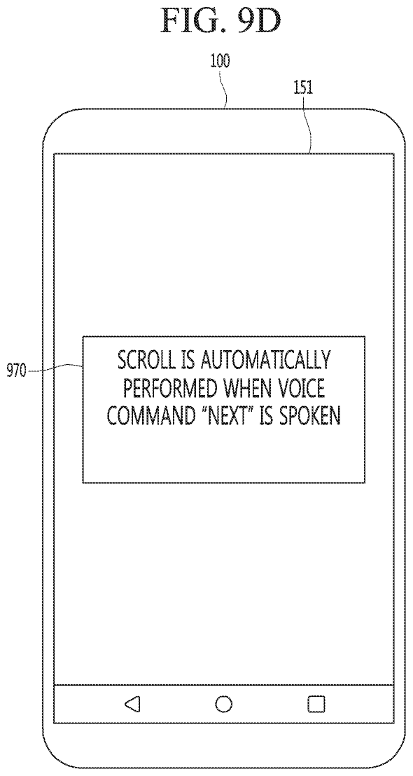

FIGS. 9a to 9d are views illustrating a process of manually registering a voice macro according to an embodiment of the present invention.

Referring to FIG. 9a, the AI device 100 may display a notification window 910 indicating that the voice macro starts to be registered manually.

Referring to FIG. 9b, the AI device 100 may detect a touch input pattern input on an execution screen 930 of an Internet application.

When the touch input pattern is detected, as shown in FIG. 9c, the AI device 100 may display a notification window 950 for requesting utterance of a voice command to match the touch input pattern on the display unit 151.

When a voice command 951 <next> uttered by the user is received, the AI device 100 may display a notification window 970 indicating that the voice macro is registered on the display unit 151, as shown in FIG. 9d.

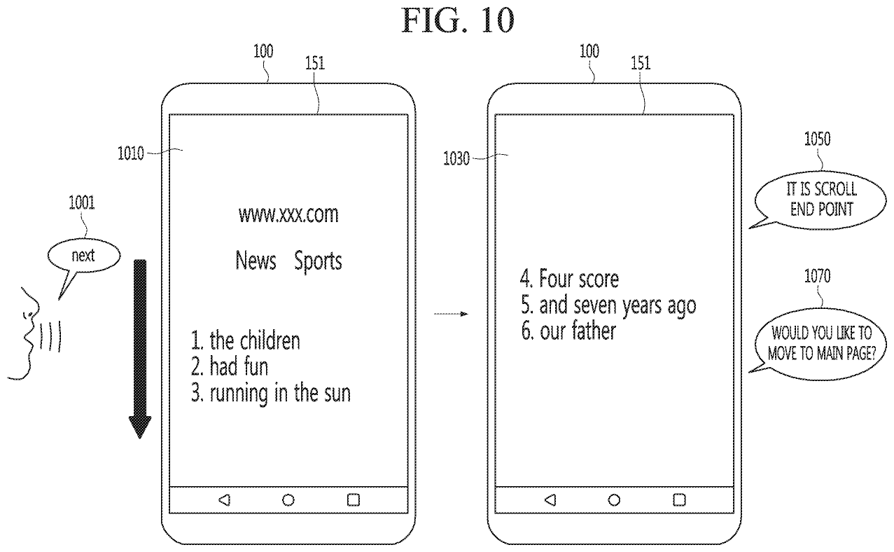

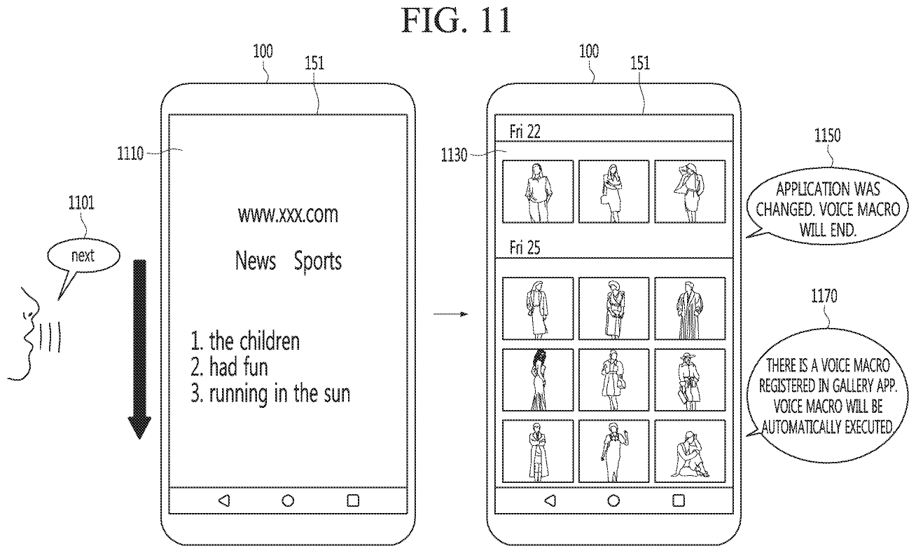

FIGS. 10 and 11 are views illustrating scenarios which may occur in a state in which operation of a voice macro cannot be performed.

First, FIG. 10 will be described.

Referring to FIG. 10, the display unit 151 of the AI device 100 displays an execution screen 1010 of the Internet application. The user uses a voice macro function matching a voice command 1001 while uttering the voice command 1001 <next>.

The voice macro function matching the voice command 1001 may be a function for performing a down scroll input pattern.

The AI device 100 may determine that operation of the voice macro is impossible upon reaching a scroll end point.

The AI device 100 may output a notification 1050 indicating why operation of the voice macro is impossible, upon determining that operation of the voice macro is impossible.

That is, the notification 1050 may indicate that the scroll end point is reached.

The notification 1050 may be displayed on the display unit 151 and may be audibly output through the sound output unit 152.

In addition, the AI device 100 may additionally output a notification 1070 for guiding a next action when operation of the voice macro is impossible.

For example, the notification 1070 may guide movement of a main web page such that the voice macro function is reused.

The notification 1070 may be displayed on the display unit 151 and may be audibly output through the sound output unit 152.

Next, FIG. 11 will be described.

Referring to FIG. 11, the display unit 151 of the AI device 100 displays an execution screen 1110 of the Internet application. The user uses the voice macro function matching the voice command 1101 while uttering a voice command 1101 <next>.

The voice macro function matching the voice command 1101 may be a function for performing a down scroll input pattern.

The AI device 100 may determine that operation of the voice macro is impossible, when the execution screen 1110 of the Internet application is changed to an execution screen 1130 of the gallery application.

The AI device 100 may output a notification 1050 indicating why operation of the voice macro is impossible, upon determining that operation of the voice macro is impossible.

That is, the notification 1050 may indicate that the executed application is changed. The notification 1050 may indicate that the execution screen of a first application is changed to the execution screen of a second application such that operation of an existing voice macro is impossible.

The notification 1150 may be displayed on the display unit 151 and may be audibly output through the sound output unit 152.

In addition, the AI device 100 may additionally output a notification 1170 indicating execution of the voice macro matching the changed application when operation of the voice macro is impossible.

For example, the notification 1170 may indicate that the voice macro corresponding to the gallery application is automatically executed.

The notification 1170 may be displayed on the display unit 151 and may be audibly output through the sound output unit 152.

According to the embodiment of the present invention, even if operation of the voice macro is impossible, it is possible to automatically execute the voice macro function according to situation change, thereby greatly improving user convenience.

According to one embodiment of the present invention, the user can easily input a touch input pattern, which has been repeatedly input, by only voice.

In addition, input control can be conveniently performed even in a state in which it is difficult for the user to use touch input.

In addition, input and control of various applications are possible even if an application does not provide a voice recognition function.

The present invention mentioned in the foregoing description can also be embodied as computer readable codes on a computer-readable recording medium. Examples of possible computer-readable mediums include HDD (Hard Disk Drive), SSD (Solid State Disk), SDD (Silicon Disk Drive), ROM, RAM, CD-ROM, a magnetic tape, a floppy disk, an optical data storage device, etc. The computer may include the controller 180 of the AI device.

What is claimed is:

1. An artificial intelligence (AI) device for providing a voice recognition function, the AI device comprising:
a microphone;
a display unit;
a memory configured to store a touch input pattern classification model; and
a processor configured to detect a touch input pattern, acquire a touch input pattern group corresponding to the touch input pattern using the touch input pattern classification model, output a notification for registering a voice macro corresponding to the touch input pattern group, and generate the voice macro by matching a voice command to the touch input pattern group as the voice command is received through the microphone.

2. The AI device of claim 1, wherein the processor performs operation of the voice macro when the voice command is received again.

3. The AI device of claim 2, wherein the voice macro is a function for a touch pattern corresponding to the touch input pattern group to the display unit.

4. The AI device of claim 3, wherein the voice macro is a function for inputting the touch pattern to the display unit when a specific application is executed.

5. The AI device of claim 1, wherein the touch input pattern classification model is an artificial neural network based model unsupervised-learned by a deep learning algorithm or a machine learning algorithm.

6. The AI device of claim 5, wherein the touch input pattern classification model is a model for classifying touch input patterns for learning into a plurality of touch input pattern groups and determining that the detected touch input pattern belongs into any one of the plurality of touch input pattern groups.

7. The AI device of claim 2, wherein the processor outputs a notification indicating that operation of the voice macro is impossible, upon determining that operation of the voice macro is impossible.

8. The AI device of claim 7, wherein the processor outputs the notification when execution of a first application corresponding to a first voice macro is changed to execution of a second application corresponding to a second voice macro.

9. A method of operating an artificial intelligence (AI) device for providing a voice recognition function, the method comprising:
detecting a touch input pattern;
acquiring a touch input pattern group corresponding to the touch input pattern using a touch input pattern classification model;
outputting a notification for registering a voice macro corresponding to the touch input pattern group; and
generating the voice macro by matching a voice command to the touch input pattern group as the voice command is received through a microphone.

10. The method of claim 9, further comprising performing operation of the voice macro when the voice command is received again.

11. The method of claim 10, wherein the voice macro is a function for a touch pattern corresponding to the touch input pattern group to a display unit.

12. The method of claim 11, wherein the voice macro is a function for inputting the touch pattern to a display unit when a specific application is executed.

13. The method of claim 9, wherein the touch input pattern classification model is an artificial neural network based model unsupervised-learned by a deep learning algorithm or a machine learning algorithm.

14. The method of claim 13, wherein the touch input pattern classification model is a model for classifying touch input patterns for learning into a plurality of touch input pattern groups and determining that the detected touch input pattern belongs into any one of the plurality of touch input pattern groups.

15. The method of claim 9, further comprising outputting a notification indicating that operation of the voice macro is impossible, upon determining that operation of the voice macro is impossible.

16. The method of claim 15, wherein the outputting of the notification indicating that operation of the voice macro is impossible includes outputting the notification when execution of a first application corresponding to a first voice macro is changed to execution of a second application corresponding to a second voice macro.
